(19) United States
(12) Patent Application Publication
(10) Pub. No.: US 2005/0016747 A1
(43) Pub. Date: Jan. 27, 2005

(54) "Ultimate jumper cables"-"stationary" model "S" and "optional" model "P"

(76) Inventor: Leslie Duane Peterson, Mountain View, WY (US)

Correspondence Address: MR. LESLIE DUANE PETERSON, 515 W. 3RD ST., P.O. BOX 526, MOUNTAIN VIEW, WY, 82939, US

(21) Appl. No.: 10/430,016

(22) Filed: May 6, 2003

(51) Int. Cl. H02G 3/08

(52) U.S. Cl. 174/50

(57) ABSTRACT

My invention idea (Ultimate Jumper Cables, Stationary and Portable Unit Models) is designed to create a new product derived from and old tool (Standard Jumper Cables), providing ease of use and storage along with added safety features currently unavailable in the old “Standard Set Of Jumper Cables”. The product is simply Jumper Cables designed onto a reel to be stored under the hood of a vehicle or any other convenient location where space availability allows. This invention may also be incorporated into any number of applications from mini (or micro size wires) to medium, and industrial size wires to provide temporary wire connections to whatever a person using them finds a need for. It can be manufactured in various sizes to meet any specific application and use of this device.

### CROSS-REFERENCE TO RELATED APPLICATIONS

Please see Application Data Sheet.

### BACKGROUND OF INVENTION

My invention pertains to the “Automotive Industry”, “The Military”, the “Marine/Boating industry, etc., and more as described in detail in “The Detailed Description Of invention” that follows (Description Of Preferred Embodiment).

### DETAILED DESCRIPTION OF THE INVENTION

### Description of the Preferred Embodiment

Description of My Idea:

My Idea: A set of “Ultimate Jumper Cables”. Designed onto a spool (or reel), enclosed in a non-electrical conductive housing that mounts conveniently under the hood of a vehicle, coiled and stored on the reel (or mounted in another convenient location, depending on space availability). The “power source” ends of the cables are directly connected into the battery terminals with a “Disconnect Switch” for the “positive” cable, for safety. In the event that location under the hood is not possible or desired, it is as simple as installing a single “positive wire” of the appropriate gage wire from desired location, “Point A to Point B” (the battery). The “negative wire” can be secured at a location as near as possible to the unit to achieve a “grounding connection”.

This “additional positive wire” could be included in the “kit” at a length of approximately 15 feet (4 to 6 gage), and approximately 3 to 5 feet for the ground wire, which would suffice for most any application, thereby minimizing multiple types of kit choices. In an application where the unit is being remotely located (other than under the hood), ideally, an in-line fuse of the appropriate amperage should be installed near the battery to protect the length of “positive wire” between the “power source” and the unit “switch”.

What It Does: The tool/product provides convenience of use and storage, along with the elimination of a coiled up set of standard “Jumper Cables” stored under the seat or some other inconvenient location, to be “drug out” and “hassled” with when needed.

How It Works: Simply open the hood (or other location). Open the Main Cable Box Lid. Remove the clamps from the “non-conductor storage bar”. Pull out the needed length of cable from the reel. Connect clamps appropriately to the “dead battery”, and turn on the switch “battery jumping” process is in operation. After completion, simply reverse the order of the procedure, with the exception of reeling” the cables back onto the spool. The reel can be designed as “self re-coiling” or “manual recoiling”, although “manual would probably prove to be more trouble free (less moving parts), and less expensive. The “Non-Conductive Storage Bar” should be molded in one piece, into the back of the case, with a “clamp separator” in the center thereof in case of switch failure (shown in drawings contained within). This will also prevent accidental “clamp to clamp contact”, to avoid shorting out the system, or creating a spark if the switch is accidentally left in the “on” position.

Have I Ever Seen Anything Similar?: No. Only the standard set of Jumper Cables currently available on the market.

What Makes My Idea Unique: No. 1—most important, is incorporating a “power switch and fuse” into the design. Thus, the potential of creating a spark near the battery during the “Battery Jumping Process” is eliminated. This is due to the fact that there is no “juice” introduced into the process until after all connections are made. In my opinion, this is a very good consumer safety feature. Other features that create uniqueness are ease of use, convenience, and storage. Further, there is always a set of “Jumper Cables” on board” (Model “S”) because by being directly connected, they cannot be “loaned out” to someone and “misplaced” when needed (“Stationary Unit Only”). The product is not “just a set of cables” thrown somewhere or even “stuck into a bag” or such. OUT OF SIGHT OUT OF MIND, AND OUT OF THE WAY UNTIL NEEDED! And then, the product/tool is easily accessible as should be.

Who Would Buy My New Product: Most anyone who owns a vehicle and wants or needs to supply it with necessary “standard emergency equipment”. This product can be made available to the consumer as a “before and/or after market item, and for companies with fleets of vehicles. Further, it would be useful for the “Automotive Industry” in general (auto manufacturers, auto dealerships, Auto Zone), the “Military”, the “marine/boating industry”, places like “Wal-Mart” and “Sears”, the “Home Shopping Network”, and of course, “The Internet”. It could be available as “optional or standard equipment”.

How Much Would Be Paid For One?: I believe that the cost for one should be between $20 to $30 more than a set of cables currently on the market today. As is common, the longer a product is on the market, the more affordable that it generally gets. Jumper cables are of course, already common. In time, it seems that this product would be nearly as affordable as what is available today, or not a whole lot more expensive.

Additional Comments: In my opinion, my invention should be constructed and assembled from a very large percentage of rugged plastic materials. The small percentage of metal parts materials is shown very obviously in the drawings and descriptions herein.

The Lid/Cover of the Main Box should be designed and built tall enough to accommodate the clamp handles so that they will not come of from the storage bar when the Lid is closed.

To continue with more issues concerning design: This product should be designed so that it can be installed in a “universal fashion”. This is to say that the “kit” be such, that the reel can be installed into the Main Box with the reel handle on the left or right side. The Contact Ring Housing can be assembled on either side of the box, including the “Optional Portable Unit Attachment” as well. This can be accomplished by having “pre-stamped”, “indented” hinge and switch holes, etc. along the bottom of the box and the front and rear (top) of the Contact Ring Housing Box. The consumer (or other person) can then drill out the appropriate holes for their particular application. This design detail creates a “universal left or right-handed” model.

Obviously, Jumper Cables have been around for a good many years. My concept is to take an “old tool” and modify plus re-design it for ease of use, convenience, and storage. This product idea, #1—In the “Stationary Model”, eliminates one pair of cable clamps (which is now common), #2—makes it easier for even the “non-mechanically inclined individual” to use it, along with all else described herein.

The “Stationary Unit”, Model “S” and “Optional Portable Unit”, Model “P”simply expands marketing possibilities immensely, in my opinion.

The Re-Coil Spring in mind for this product is the same design as the “Recoil Starter Rope Assembly” currently installed in most any “manual pull start” on a ‘gasoline powered lawn mower”, which is sized appropriately to a particular use application (overall size of unit).

In consideration of “color blind people”, the cable ends at the rear of the clamps should be physically “imprinted” with “+ and −” labels, to insure a method of their proper polarity connection of all clamps.

The clamps in my design are such that are commonly available on the market today.

In inspecting my personal set of Jumper Cables (8 gage×10 to 12 feet in length), for this product, 6 gage wire would suffice nicely (on the reel). It is my express opinion that the design is incorporated with no less than 20 feet of cable on the reel, (tentatively).

Let's face it. It's never any fun hassling with Jumper Cables, especially in a snowstorm. When the weather is cold, is usually when they are needed. So, let's make it as convenient as possible when the need for this tool/product does become necessary.

DRAWING(S) DESCRIPTION TEXT FOR FIGURE # 1 THROUGH # 16: DRAWINGS “TEXT TITLES PAGE”: (“UJC”=“ULTIMATE JUMPER CABLES” HEREAFTER)

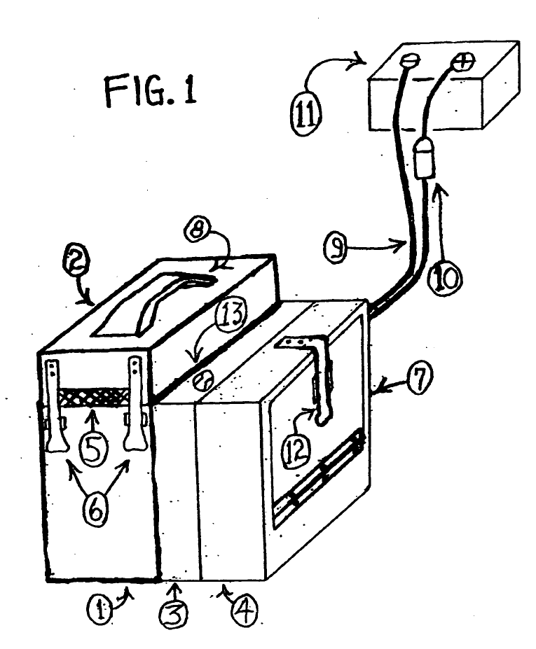

FIG. 01—UJC—OVERALL UNIT—DIMENSIONAL VIEW

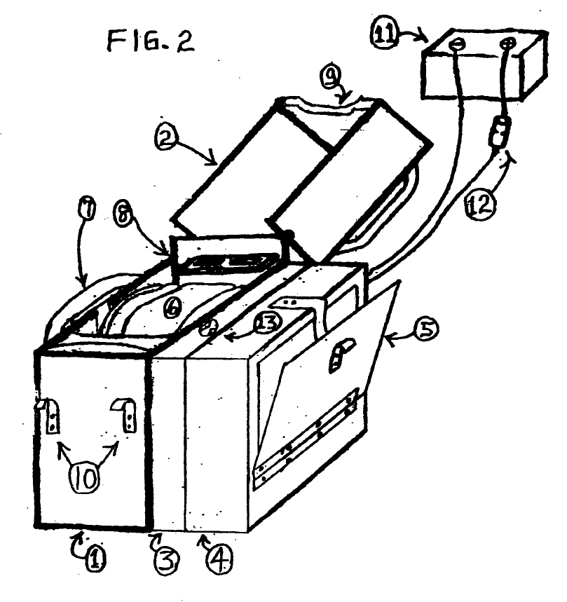

FIG. 02—UJC—OVERALL UNIT (OPEN, OPERATING) DIMENSIONAL VIEW

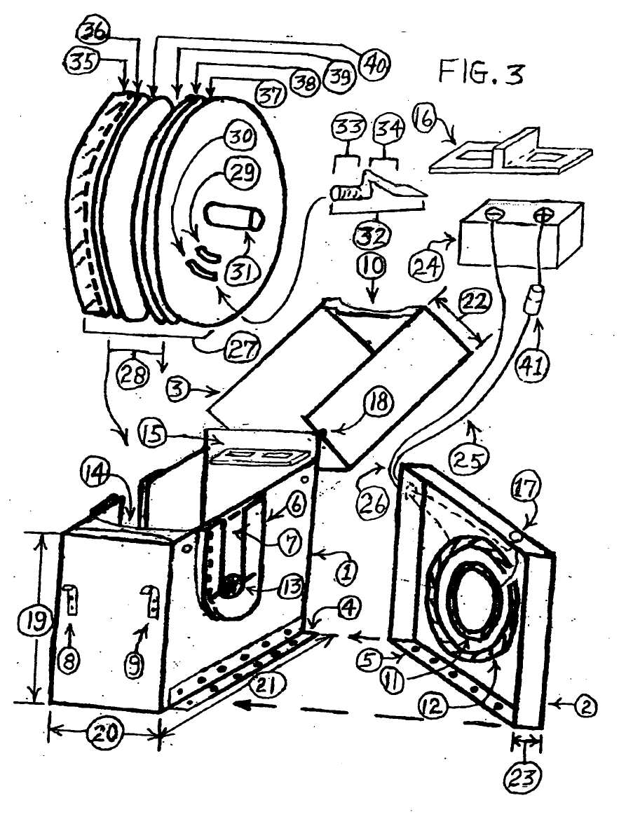

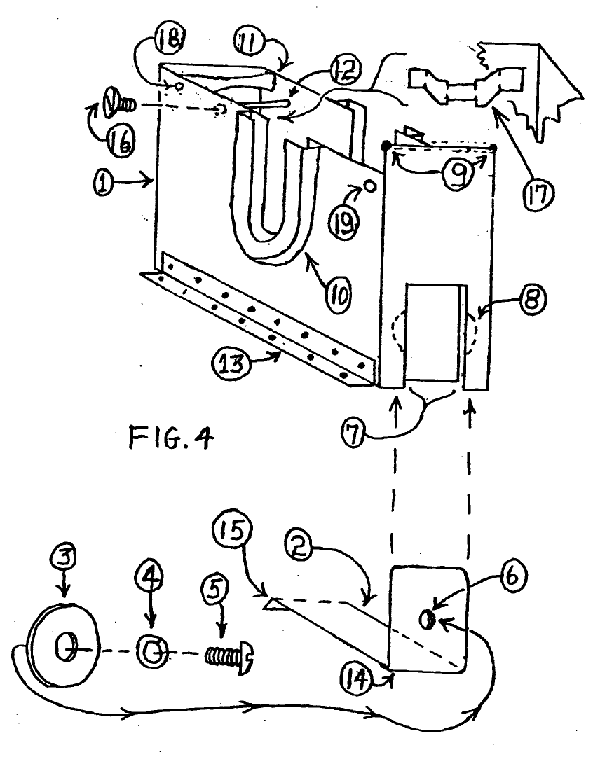

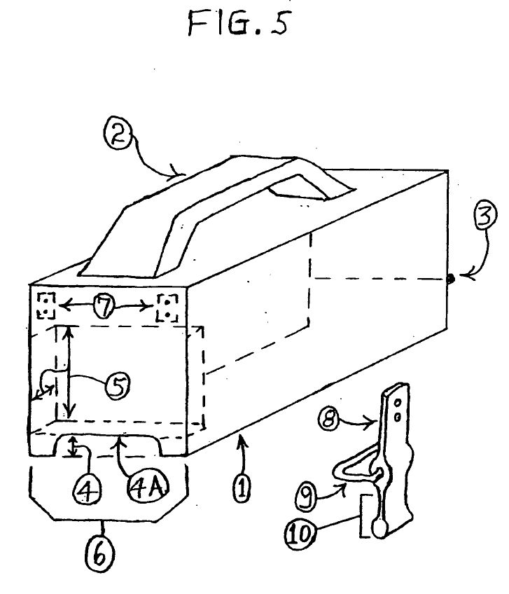

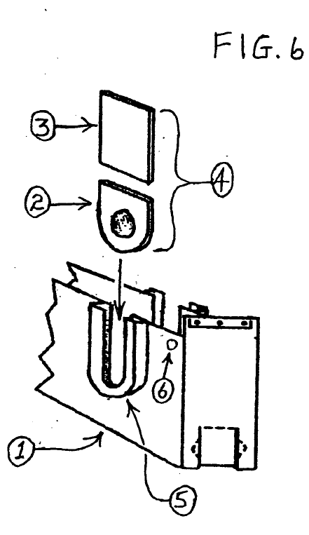

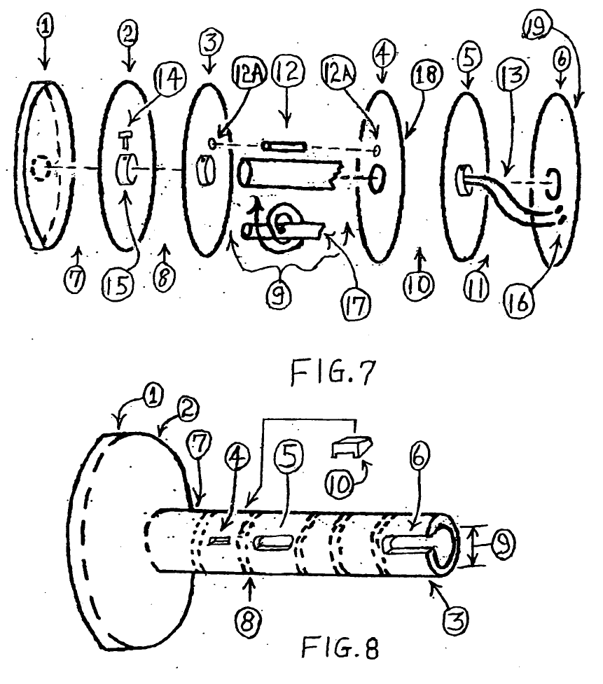

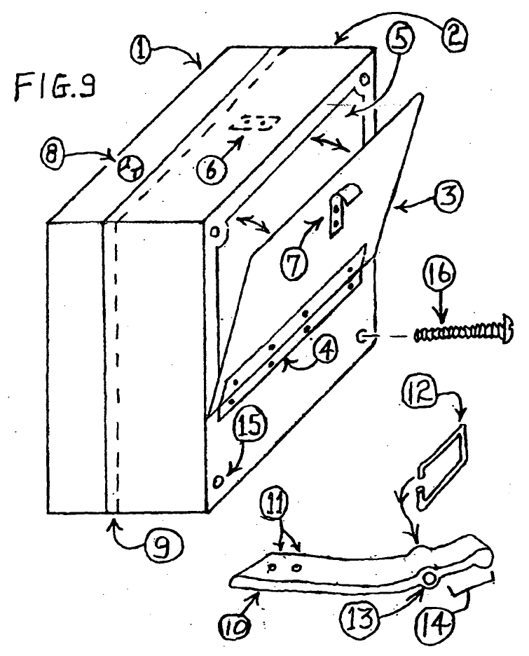

FIG. 03—UJC—OVERALL UNIT—EXPLODED DIMENSIONAL VIEW

FIG. 04—UJC—CABLE ROLLER, RECOIL SPRING HOOK LOOP, STOP PIN, AND PORTABLE UNIT SLIDE-IN CLIP-EXPLODED REAR DIMENSIONAL VIEW

FIG. 05—UJC—LID/COVER DETAIL DRAWING—DIMENSIONAL FRONT VIEW

FIG. 06—UJC—MAIN BOX—SHAFT BUSHING INSERT AND LOCK-IN PLATE DETAIL—REAR DIMENSIONAL VIEW

FIG. 07—UJC—SHAFT DISCS, CABLE STOP PIN, REEL CABLE ROUTING, AND CABLE SPOOL-OFF DIRECTION DETAILS—EXPLODED FRONT DIMENSIONAL VIEW

FIG. 08—UJC—CABLE REEL SHAFT, AND RIM/HANDLE DISC-EXPLODED DIMENSIONAL VIEW

FIG. 09—UJC—OPTIONAL PORTABLE UNIT ATTACHMENT—OVERALL OUTSIDE DIMENSIONAL VIEW

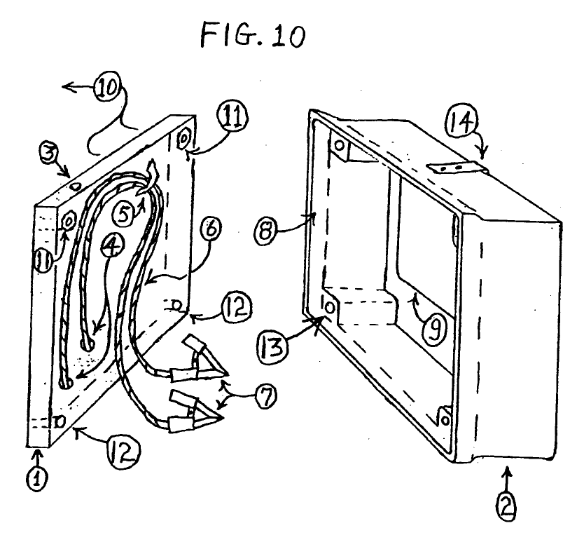

FIG. 10—UJC—OPTIONAL PORTABLE UNIT ATTACHMENT—EXPLODED OVERALL INSIDE (FRONT) DIMENSIONAL VIEW, CONTACT RING HOUSING BOX (LEFT), OUTER RIGHT SIDE DIMENSIONAL VIEW

FIG. 11—UJC—REEL SHAFT DISC #6 DETAIL DRAWING (TERMINAL CONNECTOR DISC FROM FIG. # 07, #6)—BOTH SIDES OF DlSC—EXPLODED DIMENSIONAL VIEW

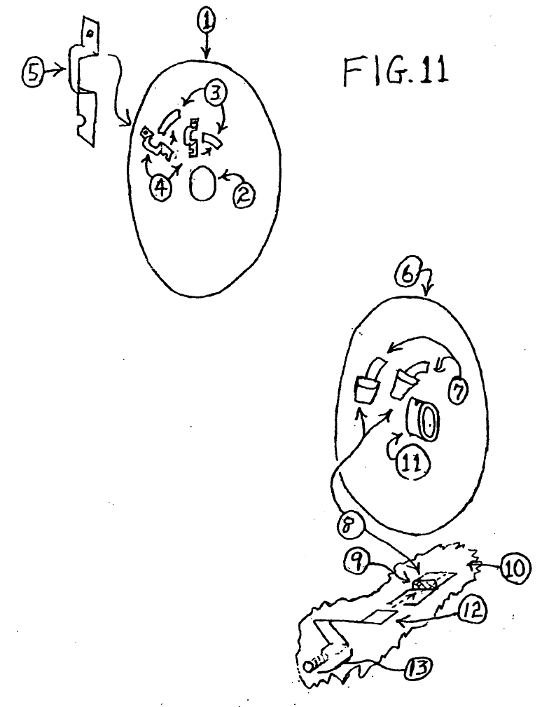

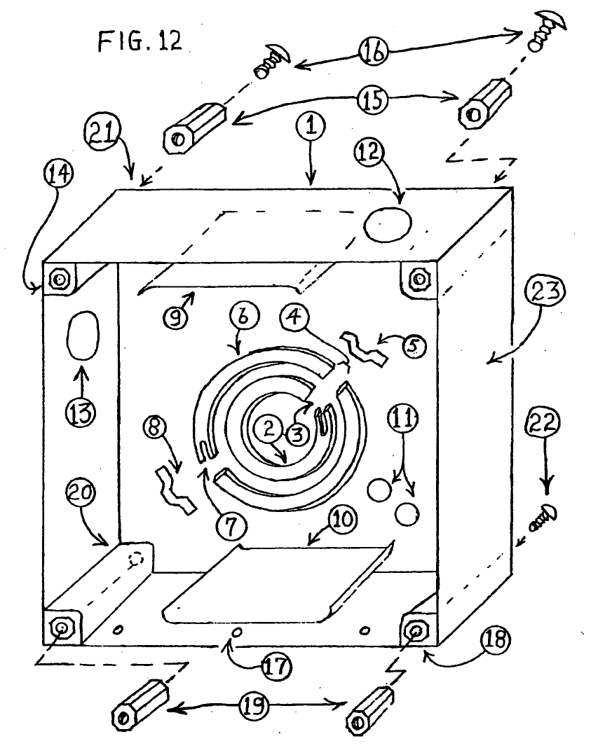

FIG. 12—UJC—CONTACT RING HOUSING BOX—INSIDE LEFT DETAIL VIEW

FIG. 13—UJC—CONCAVE CABLE ROLLER AND ROLLER PIN DETAIL (FROM FIG. 3, # 14)—EXPLODED DIMENSIONAL VIEW

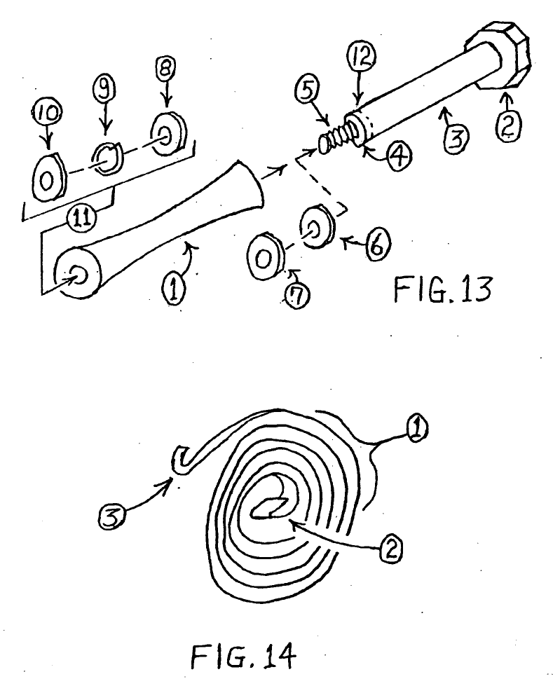

FIG. 14—UJC—CABLE REEL “RECOIL SPRING” DRAWING

FIG. 15—UJC—WIRING DIAGRAM DRAWING, MODEL “S”

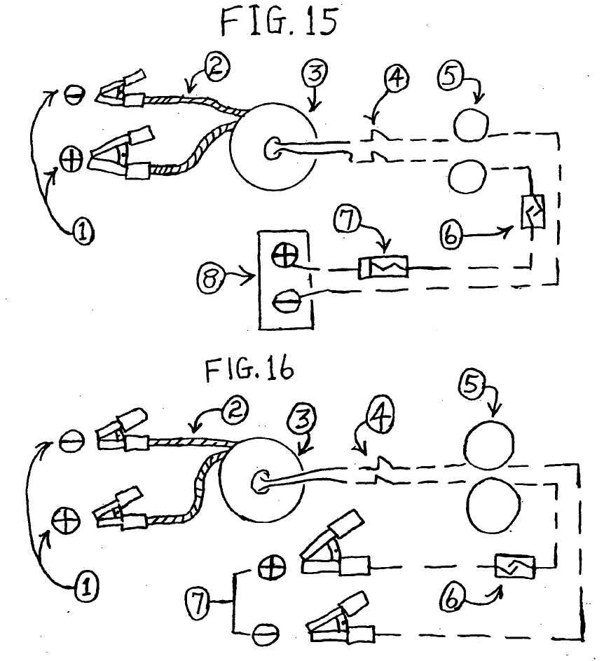

FIG. 16—UJC—WIRING DIAGRAM DRAWING, MODEL “P”

1—Main Box Reel Housing

2—Main Box Lid/Cover in closed position, with handle shown

3—Contact Ring Housing Box

4—“Optional” Portable Unit Housing Box

5—Cable Stop Exit Space

6—Rubber Strap Latches, front

7—Portable Unit Access Door, closed position

8—Handle, molded into Lid

9—“Positive” and “Negative” Cables from Unit to battery

10—In-line Fuse Holder (typical) with proper amperage fuse

11—Battery (Typical)

12—Optional Portable Unit Box—“Rubber Strap Latch”

13—“Power Switch”, typical

1—Main Box Reel Housing

2—Main Housing Box Lid/Cover, open position

3—Contact Ring Housing Box

4—“Optional” Portable Unit Housing Box

5—“Optional” Portable Unit Access Door, Open Position

6—Cable Reel

7—Cable Reel Rim Handle

8—Non-Conductive Clamp Bar

9—Cable Stop Housing

10—Rubber Strap Latch Hooks

11—Battery

12—Fuse

13—“Power Switch”, typical

1—Main Box Reel Housing

2—Contact Ring and Switch Housing Box

3—Main Box Lid

4—Hinge

5—Hinge Holes

6—Reel Lock-In Slot, Left and Right

7—Reel Lock-In Plate

8—Rubber Strap Latch Hook (Left Front Side)

9—Rubber Strap Latch Hook (Right Front Side)

10—Cable Stop Housing with proper density rubber inserted into it—“Insert, replaceable”

11—“Positive Lead” Metal Contact Ring

12—“Negative Lead” Metal Contact Ring

13—Reel Shaft Hole

14—Concave Shaped Cable Roller

15—Non-Conductive Storage Bar, for Cable Clamps Storage (molded into Main Box, #1)

16—Non-Conductive Storage Bar, Separator Detail (Molded into bar and Main Box #1)

17—“Power Switch”, typical

18—Hinge Point

19—Tentative Height, 12″ to 18″

20—Tentative Width, 3″ to 6″

21—Tentative Depth, 12″ to 18″

22—Tentative Lid Height, depending on “Clamp Handle Size”

23—1″ approximately

24—Battery (Typical)

25—“Positive” wire from Switch to Battery

26—“Negative” wire from Contact Ring to Battery or “Ground”

27—Cable Reel Assembly

28—Reel Assembly—Inserts into Main Box, #1

29—“Positive Cable” “Wire Connector Slot”

30—“Negative Cable” “Wire Connector Slot”

31—Cable Reel Shaft

32—Wire Terminal Connector Detail, “Spring Metal/Crimp” type (2 required)

33—Wire Terminal Connector “Crimping Area”

34—Wire Terminal Connector “Spring Metal” Contact Area

35—Rim/Handle Outer Disc, left side—Rim/Handle molded into disc

36—Box Insertion Space—left side

37—Cable “Exit To Wire Connectors” Space

38—Box Insertion Space—right side

39—Cable Reel “Spooling” Space

40—“Re-coil Spring” Space

41—In-line Fuse Holder (typical) with proper amperage fuse

01—Main Box Reel Housing

02—Metal Slide-In Clip—To “hook” Unit near battery during operation

03—Extra Large ¼″ flat washer

04—¼″ lock washer

05—Short ¼″ standard thread bolt

06—¼″ threaded hole

07—Clip Hook Slide-In Slot, recessed

08—¼″ flat washer snug-down area

09—Hinge Point

10—Reel Slide-In Slots (Both sides)

11—Concave Shaped Cable Roller—Insert FIG. 12, #2 (5/16″ bolt) into this side with FIG. 12, # 6, 7 (5/16″ lock and flat washer)

12—Cable Recoil “Stop Pin”

13—Contact Ring Housing Hinge

14—“90 Degree Bend” in Slide-In Clip (#2)

15—“30 Degree Bend” in Slide-In Clip (#2)

16—Flat Head Standard Bolt, to secure “Stop Pin”, both sides

17—Upper Inner Corner Detail View—Loop Bracket molded into upper inside front corner (below Cable Roller) to “hook” Recoil Spring “into”.

18—Cable Roller Pin (FIG. 12, #2) “Exit Hole”—FIG. 12, #11, slides onto 5/16″ bolt, FIG. 12, #2 (to end of ¼″ threads) between Cable Roller and inside of box. Cable Roller Pin (bolt) then screws into Contact Ring Housing Box, securing it in the closed position

19—Hole for securing Contact Ring Housing Box (Upper Rear) in closed Position (install bolt from inside of Main Box Reel Housing, #1 Note—this design can be used for Portable Unit only, or box could be manufactured the same way, utilizing a “Universal Design” for a Portable or Stationary Unit

01—Main Box Reel Housing “Lid/Cover”

02—Handle, molded into Lid, #1

03—Lid Hinge Point

04—“Cut Away” as per cable(s) diameter plus ⅛″

04A—Rubber Insertion Slot (proper density rubber inserted into slot, flush with bottom of Lid, #1—Inert, replaceable)

05—Inner “Slide-in Space” for Rubber Insert

06—Front of Lid/Cover, #1

07—Rubber Strap Latch Attacking Points, upper front, left and right

08—Rubber Strap Latch (attach to #7, 2 required)

09—Metal Hook Loop (2 required), See FIG. 9, # 12 for more detail

10—Rubber Strap Latch “Handle”
Note—This design enables the operator of the unit to hold cable(s), keeping them from “spring back” while “un-spooling” needed amount of cable by simply “pushing down” on Lid, then “re-grabbing” cable to pull out more. Once desired length is obtained, operator can then latch the lid shut on either side (or both), thus “holding” the cables in the “un-spooled” position. Further Unit Operation Procedure then continues.

01—Main Box Reel Housing (Rear Dimensional View)

02—Plastic Shaft Bushing Plate—Slide onto Reel Shaft, replaceable—(Manufacture from softer material than “Reel Disc Shaft”, FIG. 8, #3)

03—Reel Disc Shaft “Bushing Lock-In Plate”

04—Bushing and Lock-In Plate (2 of each required)

05—Bushing and Lock-In Plate Slide-In Slot Assembly (Molded into Main Box Reel Housing, # 1)

06—Bolt Hole—To secure Contact Ring Housing Box, FIG. 3, #2 in closed position (1 hole, upper right rear)

01—Rim/Handle Outer Disc (Left)—Reel Shaft glued onto this Disc, or Disc and Shaft molded as “one piece part”

02—Inner Left Disc #1

03—Inner Left Disc #2

04—Inner Right Disc

05—Outer Left Disc (Right Side of Main Box Reel Housing)

06—Outer Right Disc (Right Side of Main Box Reel Housing)

07—Left Side Box Insertion Space

08—Re-coil Spring Space

09—Cable Spooling Space

10—Right Side Box Insertion Space

11—Cable(s) Exit and Routing Space

12—Cable “Stop Pin”, secured in place with “Flat Head Bolts”, both ends

12A—Cable “Stop Pin Holes” (Insert “Flat Head Bolts, #12 through these)

13—Cable(s)/Cord

14—“Pin” or “Set Screw”

15—“Disc Collar”—Glued or molded onto all Disc(s) except # 1

16—“Slots” for Spring Metal Wire Connector Terminals, FIG. 11, #3, 7

17—Reel Cable “Spool-off Direction”

18—Disc Collar, right side of this disc

19—Disc Collar, right side of this disc

01—Rim Handle

02—Outer Left Disc

03—Reel Disc “Shaft”

04—Recoil Spring “Hook-In Slot”

05—Reel Cable “Entrance Routing Slot”

06—Cable “Exit Routing Slot”

07—Designated “Shaft Spacing(s)”

08—Designated “Disc Spacing(s)”

09—Any Diameter I.D. Reel Shaft constructed from Plastic Pipe (Typical)

10—Wedge Shaped Plastic “Plug”—insert into #4 to hold “hook” of Re-coil Spring in its slot

01—Contact Ring Housing Box, FIG. 3, #2

02—“Optional” Portable Unit Housing “Cable/Clamps Storage Box”—This “Unit” is designed to attach to the “Contact Ring Housing Box”, FIG. 3, #2/FIG. 9, #1 above. An 18″ to 24″ long set of cables (“positive” and “negative”) with a Pair of clamps connected to the opposite ends (FIG. 10, # 6, 7) will then connect to their respective “Contact Rings” through the Contact Ring Housing. These Cables and Clamps are then stored wit the Portable Unit Storage Box.

03—Portable Unit Storage Box “Access Door”

04—Access Door “Hinge”

05—“Access Door Opening”

06—Rubber Strap Latch “Attaching Point”

07—Rubber Strap Latch “Hook”

08—“Power Switch”, typical

09—Portable Unit Housing “Overlapping Lip”

10—“Rubber Strap Latch”—Attach at #6 above

11—Rubber Strap Latch “Attachment Holes”

12—Metal “Hook Loop”—Install into # 13 (below)

13—Hook Loop “Insertion Hole”

14—Rubber Strap Latch “Handle”

15—“Bolt Holes”—To fasten Portable Unit Housing Box to Contact Ring Housing Box (“Through Holes” in all 4 corners). Screw bolts into FIG. 1O, # 11,12.

16—Portable Unit “Fastening Bolts” (4 required)—To secure all 4 corners, Insert into #15.

01—Contact Ring Housing Box

02—Portable Unit Housing Box

03—“Power Switch”, typical

04—Cable “Exit Holes” from “Negative Contact Ring and “Switch”

05—Cable(s) “Tie-Down Loop Bracket” (Secures cables in place)

06—18″ to 24″ Cables with Clamps—Coil up and store inside Box, # 2 for storage

07—Battery Clamps (Typical)

08—“Overlapping Lip”—Top, bottom, front, and rear

09—Cable(s) “Access Door”

10—“To Main Reel Box Housing”, FIG. # 3, # 1

11—“Hex Shaped Through Holes”—To secure Contact Ring Housing in “closed position” and fasten Portable Unit Housing to Contact Ring Housing (bolts enter from both ends of “Top Corner Holes”.

12—“Round Shaped Bolt Holes” (this side)—To secure Portable Unit Housing Box, #2 to Contact Ring Housing at bottom corners. Insert Hex Shaped “Long Nuts” through left (inside) of bottom corners of Contact Ring Housing Box, #1

13—“Unthreaded, Through Bolt Holes”—To fasten Portable Unit Housing Box to Contact Ring Housing (all 4 corners).

14—“Rubber Strap Latch” (Partial Top View)

01—Disc #6—(FIG. 7, #6) Wire Connector Terminal “Insertion Slots Disc”—Left Side View, opposite from “Collar Side”

02—Disc #6 “Shaft Hole”

03—Terminal Connector Insertion Slots

04—Rubber Padded Hold-Down Brackets—Which “Swing or “Pivot” in and out of place, allowing “spring action” of Connectors while holding Connectors in place in “Slot”, Brackets “riveted” in place

04A—“Rubber Pad” (Glued into Bracket, # 4 above)

05—Terminal Connector Hold-Down Brackets Detail—Spring Metal Wire Terminal Connector Detail—“Swing away” Hold-Down Brackets and insert Terminal Connectors through slots, second rivet(s) serve as “Stop/Lock Pins”

06—Disc #6 (FIG. 7, # 6) “Collar Side” View (Right)

07—Wire Terminal Connector Slots

08—Wire Terminal Connector “Blade Insertion Slots”—Insert “blade” of connectors through slots and into these from opposite (left) side

09—Connector Insert Slots—“Insertion End View”, molded into right side of disc

10—Disc Surface Area, right side

11—Collar, right side of disc

12—Wire Terminal Connector(s)—“Blade end” of connector inserts through # 7 from left side of disc and into” # 9, allowing “spring” portion of connector to protrude through disc to right side of disc. “Crimp” portion of connector remains on left side of disc, being held in place with # 4.

13—This portion of Wire Terminal Connector remains on left side of disc (#1)

01—Contact Ring Housing Box—Fastens to FIG. # 1, # 1 with hinge (# 17 and “bolts to fasten closed” through FIG. # 12, # 14, shown below)

02—Plastic “Raised Positive Contact Ring Surface” (Molded into housing, # 1)—Cables (“+” and “−”) are soldered onto the “Metal Contact Rings”, the Metal Contact Rings are then glued with an epoxy adhesive type glue, to the “Raised Contact Ring Surfaces”.

03—“Positive Cable and Metal Contact Ring Soldering Space”

04—“Positive Cable Exiting Space Route”

05—Positive Cable “Hold-Down Loop” (Molded into Housing, # 1)

06—Plastic “Raised Negative Contact Ring Surface”

07—“Negative Cable and Metal Contact Ring Soldering Space”

08—Negative Cable “Hold-Down Loop” (Molded into Housing, # 1)

09—Positive Cable “Routing Shield” (used for Model “S” only)

10—Negative Cable “Routing Shield” (used for Model “P” only)

11—Positive and Negative Cables “Exit To Portable Unit Holes”—To maintain “Model “S and P” universality, cables from Switch and Negative Contact Ring must be “wire nutted” for Model “S or “P” application, then routed to battery or Portable Unit. These holes (#11) require Rubber “Plugs” for Model “S”

12—“Switch Installation Hole”, typical

13—Model “S” “Cables Exit To Battery Hole” with Rubber “Boot Insert”

14—Hex Shaped “Long Nut Insertion Hole”, both top corners

15—“Hex Shaped “Long Nuts”

16—“Short Bolts”

17—“Hinge Holes”

18—Hex Shaped “Long Nut Insertion Hole”

19—Hex Shaped “Long Nuts”

20—“Round Hole”, this side, both bottom corners, to “stop” Long Nuts

21—Hex Shaped Holes, top corners only, “all the way through”

22—“Short Bolts” (Replace # 22 here and # 16 above with Long Bolts for Model “P” application)

23—“Front” of Box
Additional Notes: Metal Contact Rings should be fabricated from “thick enough material” to prevent “weak spots” in the “spaced areas”, # 3, 4, and 7 of the “Raised Ring Surfaces”

01—Cable Roller—See FIG. 4, #11

02—Cable Roller “Pin”—Insert through Main Reel Box Housing, FIG. 4, #11, (Lubricate Pin first).

03—5/16″ Diameter “Pin Area”

04—“Shoulder” Area of Pin

05—¼″ Diameter Standard Threads

06—5/16″ Diameter Flat Washer—For (Outside) Left of Main Reel Housing Box

07—5/16″ Diameter Flat Washer—For (Inside) Left of Main Reel Housing Box, “Rider Washer”

08—5/16″ Diameter Flat Washer—Cable Roller “Rider Washer”, inside right

09—¼″ Lock Washer

10—¼″ Flat Washer

11—Slide this entire assembly onto Pin, #2 (in this order) after sliding Roller (#1) onto Roller Pin, #2 which all installs on the “inside” of Main Reel Housing Box, FIG. 4, #1 between Roller and Box. Roller Pin Bolt, (#2) then extends and exits through FIG, 4, #18 and screws plus tightens into Contact Ring Housing, thereby securing it's Upper Front Corner. This tightening point allows the Cable Roller to turn freely yet secure the Contact Ring Housing in closed position at this location

12—Point at which the Roller Pin, #1 extends to—5/16″ Flat Washer, #8 Stay between #4 and #12 and “floats”.

01—Reel/Disc Recoil Spring—Typical type that is used in a “Starter Rope Recoil Assembly” on a “Gasoline Pull Start Lawnmower”

02—“Center Recoil Spring Hook”—Hooks into FIG. # 8, # 4 insertion Slot

03—“Outer Recoil Spring Hook”—Hooks into # 17 inside of Main Housing Box, FIG. # 4,# 17

01—Positive and Negative Clamps” to “Disabled Battery”

02—“Positive and Negative Cables”

03—Positive and Negative “Cable Reel”

04—Positive and Negative “Wire Terminal Connectors”

05—Positive and Negative “Metal Contact Rings”

06—“Switch”, typical

07—“Fuse”, typical

08—“Good Battery”, typical

01—“Positive and Negative Clamps” to Disabled Battery

02—“Positive and Negative Cables”

03—Positive and Negative “Cable Reel”

04—Positive and Negative “Wire Terminal Connectors”

05—Positive and Negative “Metal Contact Rings”

06—“Power Switch”, typical

07—“Positive and Negative Clamps” to “Good Battery” (Model “P” Unit)

### BRIEF SUMMARY OF INVENTION

This invention, is simply a Cable Reel enclosed in a “non-electrical conductive and waterproof box”, which can provide temporary or permanent connection for a specific and particular application of the device. The cable(s) may be “unspooled” to any necessary length to achieve connection from Point A to Point B, providing constant connection at any length “unspooled”, and then easily re-spooled onto reel by the user when connection is no longer needed, thus being conveniently “stored” on the reel in the box.

1. The concept of a flexible set of cable(s) on a reel (spool) which provide a “constant electrical or continuity contact”, regardless of how much cable length is “unspooled” from the reel. Said set of cable(s) may contain any number of “flexible rubber insulated” “electrical” or “continuity contact” wires, of any wire gauge size, as is necessary for a particular specific application of this overall device, stationary or portable, which provide temporary or permanent connection(s).
I do not claim invention rights to any “wire conductor(s), connectors, clamps, switches, or fuses, but merely the use thereof in my overall design as described herein, with the exception of the Wire Terminal Connector shown in FIG. 3, #32, 33, & 34 and FIG. 11, #12, hereby which I do claim.

2. I claim the invention design as sown in FIG. 1, #1 through #5
FIG. 2, #1 through #9
FIG. 3, #1, 2, 3, 6, 7, 10, 11, 12, 13, 14, 15, 16, 18, 27, 28, 29, 30, 31, 32, 33, 34
FIG. 4, #1, 2, 7, 8, 9, 10, 11, 12, & 17
FIG. 5, #1, 2, 3, 4, 4A, & 5
FIG. 6, #1 through #6
FIG. 7, #1 through #13 and #15 through #19
FIG. 8, #1 through 10
FIG. 9, #1, 2, 3, & 9
FIG. 10, #1, 2, 4, 5, 8, 9, 10, 11, 12, & 13
FIG. 11, #1 through 13 with the exception of the “rivets”
FIG. 12, #1, 2, 3, 4, 5, 6, 7, 8, 9, 10, 11, 13, 14, 18, 20, & 21
FIG. #13, #1, 2, 3, & 4
FIGS. 15 & 16 in their overall schematic layout configuration only.
